(19) United States
(12) Patent Application Publication
(10) Pub. No.: US 2026/0066654 A1
(43) Pub. Date: Mar. 5, 2026

(54) ELECTRICITY PEAK DEMAND FORECAST MEDIATED GRID MANAGEMENT PLATFORM

(71) Applicant: Camus Energy Inc, Campbell, CA (US)

(72) Inventors: David Stuebe, Campbell, CA (US); Akhilesh Bakshi, Campbell, CA (US); Dylan Cutler, Campbell, CA (US); Michael Hutson, Campbell, CA (US)

(21) Appl. No.: 19/306,907

(22) Filed: Aug. 21, 2025

Related U.S. Application Data
(60) Provisional application No. 63/688,205, filed on Aug. 28, 2024.

(51) Int. Cl. H02J 3/00; G06N 7/08

(52) U.S. Cl. CPC H02J 3/003; G06N 7/08; H02J 2103/30; H02J 2103/35; H02J 2105/53; H02J 2105/55

(57) ABSTRACT

A grid management platform is disclosed for predicting and mitigating peak electricity demand events using probabilistic modeling and cost-optimized control. The system includes a likelihood model that evaluates the probability of each remaining day within an evaluation interval being the peak load day. This is achieved through a Monte Carlo simulation engine that generates multiple stochastic realizations of future load trajectories based on historical data, forecast data, and forecast error profiles derived from back testing. The system computes likelihood scores and classifies days using optimized bin thresholds that minimize operational cost, considering demand charges, available distributed energy resources, and forecast uncertainty. Based on the predicted likelihoods, the platform generates actionable insights and transmits control signals to grid-connected assets such as batteries, HVAC systems, and electric vehicle chargers to shift or reduce load during predicted peak periods.

### CROSS-REFERENCE TO RELATED APPLICATIONS

This application claims the benefit of and priority to U.S. Provisional Patent Application No. 63/688,205 filed on August 28, 2024, the disclosure of which is hereby incorporated by reference in its entirety for all purposes.

### TECHNICAL FIELD

This disclosure generally relates to the electricity grid management platform, and more particularly to methods and systems for electricity peak demand forecast-mediated grid management.

### BACKGROUND

In modern electric power systems, particularly those supporting smart grids and distributed energy networks, effective management of peak demand events is essential to ensuring grid reliability and avoiding infrastructure stress. Peak electricity demand events, often occurring on a small number of high-consumption days per year, are disproportionately responsible for high demand charges and capacity market costs incurred by utilities, large consumers, and grid operators. In response, many organizations implement demand response (DR) programs, deploy distributed energy resources (DERs), or engage in load shaping strategies to mitigate these operational impacts.

Conventional approaches to peak prediction, however, rely heavily on deterministic forecasting models that provide a single load estimate per future day. While these forecasts may be accurate under normal conditions, they do not capture the uncertainty inherent in external factors such as weather variability or system noise. As a result, deterministic forecasts may incorrectly identify peak days, leading to either over-preparation, where DERs or curtailment strategies are unnecessarily activated, or under-preparation, where no mitigation is taken and avoidable peak-related penalties are incurred.

Furthermore, existing systems often lack integration between forecasting and control, treating the prediction process as isolated from the dispatch or control logic. This siloed architecture limits responsiveness and does not enable predictive optimization based on real-time data or forecast revisions. Many implementations also rely on static rule-based thresholds to trigger control actions, without optimizing these rules based on actual system constraints, leading to inefficient or misaligned operational responses.

These limitations highlight the need for an integrated, adaptive, and probabilistically informed grid management system.

### SUMMARY

To address the aforementioned shortcomings, a method and a system for electricity peak demand forecast-mediated grid management are provided. The disclosed method and system evaluate the probability of a peak occurring on a given hour and day based on the uncertain forecast for the remainder of the evaluation period (e.g., month, year, or the like) and the observed load to date. The resulting probabilities are evaluated by an optimal decision support tool to recommend actions that reduce peak demand.

In one aspect, the present disclosure provides a grid management system, including a processor; and a memory, coupled to the processor, configured to store executable instructions that, when executed by the processor, cause the processor to receive historical data and forecast data for an evaluation interval and determine a likelihood, using a likelihood model, that each remaining day in the interval will be a peak load day; generate a plurality of stochastic realizations of future load values via a simulation; compute, for each day, a likelihood based on a frequency that the day is the peak load day across the realizations; and generate actionable insights or control signals for controlling grid-connected assets based on computed likelihoods.

In another aspect, the present disclosure provides a method for electricity peak demand forecast-mediated grid management, including receiving historical data and forecast data for an evaluation interval; generating a plurality of stochastic realizations of future load values using a simulation process; determining, for each day in the interval, a likelihood of being the peak load day based on simulation outcomes; and generating actionable insights or control signals for controlling grid-connected assets in response to determined likelihoods.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures(or drawings). A brief introduction of the figures is below.

FIG. 1 shows a schematic diagram of an example system architecture of a grid management platform, and specifically the steps taken to make a recommendation for grid management action, according to an embodiment of the disclosure.

FIG. 2 shows a schematic diagram of an example system architecture for training a likelihood model, according to an embodiment of the disclosure.

FIG. 3 shows some example deterministic forecasts with associated error ranges by a load forecast model.

FIG. 4 shows some example realizations of a Monte Carlo simulation of peak load in megawatts.

FIG. 5 shows some example likelihoods calculated based on a Monte Carlo simulation.

FIG. 6 shows an example classification of predicted likelihoods for an evaluation period.

FIG. 7 shows an example comparison of the load forecast between a baseline forecast model and a subseasonal weather forecast model.

FIG. 8 shows an example of forecast error by forecast horizon.

FIG. 9 shows an example of predicted load by comparing a baseline forecast against a subseasonal weather forecast model.

FIG. 10 shows a confusion matrix of peak call performance using the empirical cumulative distribution function method vs. the simulation approach outlined in this invention application, demonstrating improved performance using the same input features.

FIG. 11 is a block diagram of an example computer for implementing the technology disclosed herein, according to an embodiment of the disclosure.

### DETAILED DESCRIPTION

The Figures(FIGS.) and the following description relate to some embodiments by way of illustration only. It should be noted that from the following discussion, alternative embodiments of the structures and methods disclosed herein will be readily recognized as viable alternatives that may be employed without departing from the principles of the disclosure.

Reference will now be made in detail to several embodiments, examples of which are illustrated in the accompanying figures. It is noted that wherever similar or like reference numbers may be used in the figures, they may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Motivation and Benefits

The present disclosure addresses several technical challenges encountered in modern grid management, particularly in the context of peak load forecasting and control. One of the primary technical problems lies in the uncertainty associated with predicting peak electricity demand days. Existing approaches often rely on deterministic models that output a single-point forecast without quantifying the confidence or likelihood of that forecast. This lack of uncertainty modeling makes it difficult for utilities or facility operators to plan ahead or to make informed decisions about load shifting, resource deployment, or participation in demand response programs. As a result, operators may either under-prepare (e.g., missing opportunities to mitigate demand charges) or over-prepare (e.g., unnecessarily deploying expensive resources when peak events do not materialize).

Another technical challenge is the inefficiency in triggering DERs or load control systems based on inaccurate forecasts. Without a probabilistic assessment of which days are likely to be peak load days, control actions such as discharging batteries, curtailing non-critical loads, or sending alerts to users may be either too aggressive or too conservative. Moreover, many legacy systems treat forecasting and control as isolated functions. This leads to disjointed operations, where control decisions are not informed by the most up-to-date probabilistic assessments. Such static designs hinder operational agility, especially in time-sensitive grid environments like those governed by 12 coincident peak (12 CP) or capacity charge mechanisms.

To address these issues, the present disclosure introduces a novel grid management platform that incorporates a likelihood model built around a Monte Carlo simulation engine. This engine stochastically generates thousands of plausible future load scenarios by sampling from forecast error distributions derived from rigorous back testing. Each scenario reflects a possible evolution of daily load values over the evaluation period, taking into account weather variability, historical patterns, and real-time forecast data. By aggregating these scenarios, the system calculates a day-specific likelihood score indicating the probability that each day will represent the peak demand of the interval. This probabilistic framework introduces a robust method for quantifying uncertainty and enables dynamic risk assessments rather than relying on single-point forecasts.

In addition to the probabilistic load modeling, the platform introduces a cost-optimized binning mechanism for classifying days into categories such as “Very Likely,” “Likely,” and “Unlikely” peak days. Unlike static thresholding schemes, this system uses a cost function that considers factors such as demand charges, DER availability, forecast horizon, and control constraints. The optimal thresholds are selected based on simulated outcomes that minimize overall system cost, including the cost of missed peaks, false positives, and resource misallocations. This approach ensures that the classification strategy is rational and aligned with grid operator priorities.

Another technical advancement lies in the integration of real-time data streams and daily re-simulation capabilities. As new data becomes available, such as updated weather forecasts or newly observed load values, the system re-trains or re-evaluates its predictions accordingly. This ensures that the likelihood assessments and subsequent control actions remain accurate and relevant throughout the evaluation interval. The system also includes an assembly unit that preprocesses historical, forecast, and error data, and a likelihood calculation unit that transforms simulation outcomes into actionable probabilities.

Based on these probabilistic assessments, the grid management platform generates actionable insights and control signals for DERs and flexible load assets. For instance, on a day classified as “Very Likely” to be a peak, the platform may send signals to discharge a battery, pre-cool a building, delay EV charging, or activate DR incentives. These control actions can be automated, rule-based, or sent to operators as alerts via email or platform interfaces. The seamless linkage between likelihood-based forecasting and operational execution provides a comprehensive and intelligent control framework that improves efficiency, enhances grid reliability, and supports decarbonization goals.

Overall, the disclosed platform offers significant technical advantages. It enhances peak prediction accuracy by modeling uncertainty explicitly; it enables optimized resource control through probabilistic classification; and it improves responsiveness and reliability through real-time updating and integrated control. These improvements directly address longstanding limitations in grid planning and peak load management, enabling smarter, more adaptive grid operations.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

### System Architecture

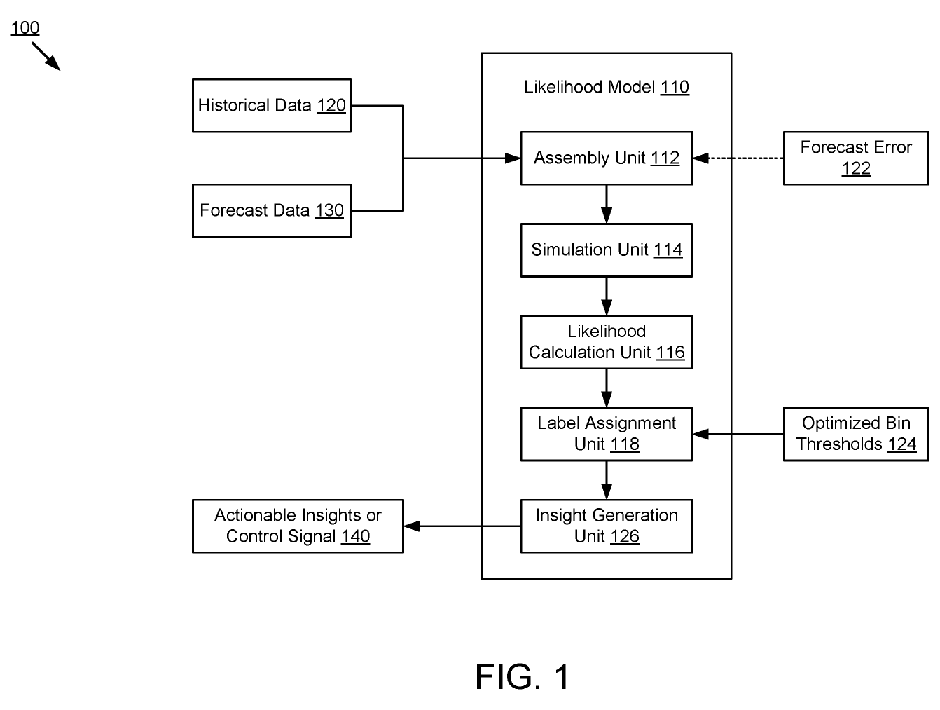

FIG. 1 illustrates a schematic diagram of an example system architecture for a grid management platform 100, or a portion thereof, in accordance with one embodiment of the present disclosure. As shown, the grid management platform 100 includes a central likelihood model 110, which is responsible for evaluating the probability of a peak load event occurring on each remaining day within a defined peak evaluation period. To make this determination, the likelihood model 110 integrates multiple sources of input data, including historical data 120 (e.g., past load behavior and exogenous variables) and forecast data 130 (e.g., predicted future demand and weather conditions).

The core function of the likelihood model 110 is to process these inputs, in combination with forecast uncertainty models potentially derived through back testing, to produce a likelihood score or classification for each day in the evaluation window. These classifications may include designations such as “Very Likely,” “Likely,” or “Unlikely” to indicate the relative probability of peak occurrence.

Based on the assessed likelihoods, the grid management platform 100 is configured to generate actionable insights or control signals 140, which may include either recommendations for human operators or automated control signals issued to DERs. In particular, when a peak load event is deemed highly likely, the system may initiate control actions to reduce net load on the grid. These actions may include dispatching generation assets such as battery energy storage systems or backup generators and/or reducing consumption from controllable load assets, such as electric vehicle chargers, heating, ventilation, and air conditioning (HVAC) systems, or industrial equipment.

The transmission of these control signals is performed in a timely and anticipatory manner, ensuring that the mitigation strategy is aligned with the predicted timing of the peak. This proactive control framework enables grid operators to avoid costly demand charges, reduce exposure to wholesale market spikes, and enhance system stability without compromising service quality.

According to some embodiments, the likelihood model 110 may be broken into smaller units. In one example, the likelihood model 110 may include an assembly unit 112, a simulation unit 114, a likelihood calculation unit 116, a label assignment unit 118, and/or an insight generation unit 126, which generates actionable insights or control signals 140, as illustrated in FIG. 1.

The assembly unit 112 is a data ingestion and preprocessing unit that is configured to take the historical data 120 and the forecast data 130 and prepare these data for simulation by the simulation unit 114. As illustrated in FIG. 1, in some embodiments, the forecast error data 122 from back testing may also be collected by the assembly unit 112 and used for simulation.

The historical data 120 refers to the observed electricity load values recorded prior to the start of the forecasted evaluation interval. This data serves as a foundational input to the disclosed likelihood model 110 and may be sourced directly from the distribution facility’s internal metering infrastructure or from external data aggregators or third-party service providers, depending on the system configuration. The historical data provides essential context for identifying trends, anomalies, and repeating patterns that influence future peak load behavior.

In some embodiments, in addition to raw historical load values, the historical data 120 may include exogenous factors that are known to influence electricity demand. These may include, for example, hourly market price data, weather observations, or economic indicators. Such contextual variables are instrumental in capturing non-linear dependencies between grid conditions and consumption behavior, thereby improving the performance of both the load forecast model and the Monte Carlo simulation.

The temporal depth of the historical data may vary depending on the evaluation scenario. In certain use cases, data spanning the past several months may suffice for short-term peak prediction, while in others, multi-year datasets may be used to detect seasonal or inter-annual load behavior, such as in 12 CP forecasting for demand charges. Longer data windows may also enable robust statistical analysis and model retraining to ensure long-term accuracy and adaptability.

In some embodiments, the historical data 120 may further include derived insights or engineered features generated through advanced analytics. For example, patterns in the load curve, such as time-of-use clusters, demand ramp rates, or recurring peak times, may be identified using statistical learning techniques or generative AI units. These insights may be encapsulated as metadata or embedded features and provided as input to the simulation unit or forecast model to improve predictive accuracy. In this manner, the historical data 120 becomes not only a repository of past measurements but also a structured foundation for intelligent pattern recognition and decision support within the likelihood-based peak prediction framework.

With respect to the forecast data 130, it may encompass the predicted future electricity load for either a specific distribution facility, a collection of facilities, or a broader jurisdiction such as that managed by a balancing authority. The forecast data 130 serves as a important input to the disclosed likelihood model 110, enabling the estimation of the probability that any given day within the evaluation period will correspond to a peak load event. To generate this data, the system may employ a diverse set of forecasting models, depending on the desired balance between precision, uncertainty modeling, and computational efficiency.

In some embodiments, the system utilizes deterministic forecast models, which provide a single-point estimate of future load for each day. These models may be analytical (e.g., based on regression or time series decomposition) or machine learning-based (e.g., gradient boosting, neural networks), and may be accompanied by statistical confidence intervals or error bands to represent the expected deviation from the point forecast.

In some embodiments, or in conjunction with deterministic methods, the system may also incorporate stochastic forecast models, which generate probabilistic estimates by producing distributions of possible load outcomes for each future day. These models may directly account for forecast uncertainty and are particularly useful when integrated into downstream simulations such as Monte Carlo processes, where each sample is drawn from the predicted distribution rather than centered solely on the mean.

The use of multiple forecast methodologies allows the system to adapt dynamically to different temporal horizons, weather variability, or user-defined risk tolerance. This flexibility ensures that the likelihood model produces not just accurate predictions, but actionable probabilistic assessments of peak risk that account for real-world uncertainty and system variability.

In one specific embodiment, the load forecast model (i.e., the likelihood model 110) disclosed herein may be implemented as a machine learning-based time series model employing an autoregressive approach, where future load values are predicted based on a combination of past load values and exogenous variables. The model may be designed within a composable framework, such as that provided by the open-source scikit-learn library, allowing modular configuration, easy integration of preprocessing pipelines, and flexible tuning of hyperparameters. This composable architecture promotes adaptability, enabling rapid experimentation with different model types (e.g., linear regression, gradient boosting, random forest) and efficiency, allowing seamless retraining as new data becomes available.

In some embodiments, the load forecast model may incorporate a rich set of temporal and environmental features to improve accuracy across multiple forecasting horizons. These features may include seasonality components, such as annual, weekly, and hourly cycles, as well as weather-related variables, including but not limited to temperature, humidity, rainfall, and solar irradiance. By embedding these features, the model may capture both long-term structural patterns and short-term weather-driven load fluctuations.

In some embodiments, to further enhance performance, particularly over extended time horizons, the system may utilize multi-source weather-powered forecasts. In such embodiments, weather forecasts from multiple providers are integrated, each optimized for different lead times (e.g., short-term precision versus long-term trends). For example, in a 12 CP forecasting use case, the platform may perform daily forecasts up to seven days into the future and weekly forecasts extending up to five weeks, aligned with the duration of peak evaluation periods. Each weather source is selected based on its forecast reliability for a given horizon, thereby tailoring the input quality to the model’s needs.

Moreover, the system may aggregate multiple forecasts across different time resolutions and horizons into an ensemble, thereby improving robustness. In this multi-horizon ensemble approach, it is noted that forecast error tends to grow with the forecast horizon. As such, appropriate uncertainty quantification may be applied to each forecast window, and these confidence intervals are propagated into the Monte Carlo simulation that drives peak likelihood classification. This approach ensures that the system is both responsive to near-term volatility and aware of long-range uncertainty, enabling more accurate and economically informed operational decisions.

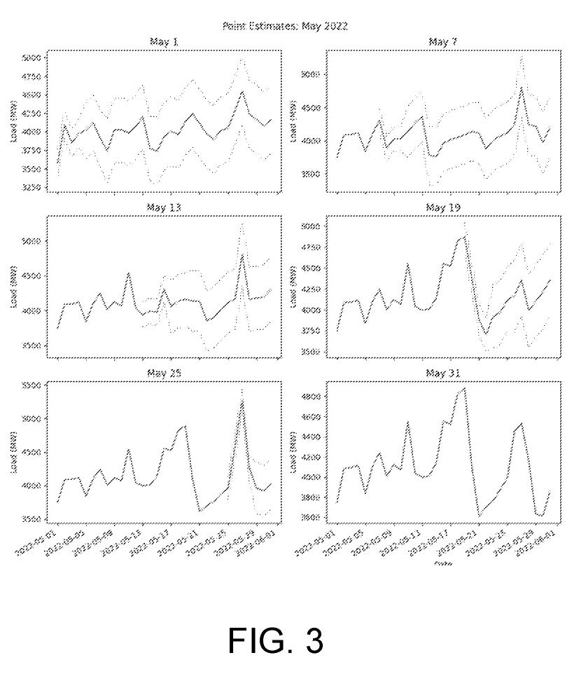

FIG. 3 presents a series of deterministic load forecasts with associated uncertainty intervals, illustrating how forecast evolution and uncertainty propagation impact the identification of peak load days over a monthly evaluation period. The example focuses on May 2022 and includes forecast snapshots initialized on multiple starting dates: May 1, May 7, May 13, May 19, May 29, and May 31, 2022. Each plot in the figure corresponds to one of these forecast initiation dates and depicts the predicted load values for future days, shown with associated error bars to represent forecast uncertainty. Points without error bars denote actual observed load values that were known at the time of forecast issuance.

In the early forecasts, specifically those generated on May 1, May 7, and May 13, the deterministic model predicts that the peak load for May will occur on May 27, 2022, likely driven by forecasted warm weather or expected end-of-month demand growth. However, on May 18, a significant and unexpected spike in actual observed load occurs. This anomaly prompts a substantial revision in the forecast issued on May 19, which now identifies May 19 as the most probable peak day for the month. This shift underscores the sensitivity of peak forecasting to sudden load changes and highlights the need for adaptive re-evaluation based on real-time data.

As additional days pass and more actual load values are observed, the forecast is again revised. In the projections initialized on May 25, the model reverts to predicting May 27 as the most likely peak day, presumably because the earlier spike on May 19 is viewed as an outlier and no further increases are projected before the end of the month. However, in the final retrospective view (as seen in the May 31 plot with actual load fully available), May 19 is confirmed as the true peak load day for May 2022.

This example illustrates two essential aspects of the disclosed system. First, it demonstrates how forecast error and load volatility can significantly affect the perceived timing of peak events over the course of a month. Second, it highlights the importance of the likelihood model’s simulation engine, which integrates forecast uncertainty to provide a probabilistic assessment rather than relying solely on deterministic predictions. This probabilistic insight is essential for the grid management platform to make informed operational decisions, such as triggering demand response, dispatching energy storage, or issuing peak warnings, based on evolving and uncertain information.

Referring back to FIG. 1, in some embodiments, the Monte Carlo simulation performed by the simulation unit 114 incorporates not only the historical data 120 and forecast data 130, but also forecast error data 122 obtained through a process of back testing. Back testing refers to the retrospective evaluation of a predictive model using historical data for which the actual outcomes are already known. It serves as a specialized form of cross-validation, tailored to time-series modeling, in which the model’s performance is assessed on previously unseen historical intervals.

Through back testing, the system may identify systematic or random deviations between predicted and observed load values generated by the deterministic or stochastic forecasting models. These deviations are then quantified into statistical distributions (e.g., mean bias, standard deviation, autocorrelation) that characterize the forecast uncertainty. This uncertainty is injected into the Monte Carlo simulation process to ensure that each simulated realization not only reflects expected demand trends but also realistically models the inherent variability and potential error of the forecast itself. By doing so, the simulation more accurately estimates the likelihood of peak load occurrence for each remaining day of the evaluation period, yielding more robust and credible risk assessments.

In some embodiments, once the historical load data 120, forecast data 130, and forecast error data 122 are retrieved or computed, they are processed by an assembly unit 112, which performs the necessary data preprocessing operations required for simulation readiness. The assembly unit 112 may carry out multiple preprocessing tasks, including but not limited to data cleaning (e.g., handling missing values, filtering out anomalies), feature engineering (e.g., constructing lagged variables, identifying seasonal patterns, encoding calendar features), and data transformation (e.g., normalization, resampling, or structuring into time-aligned data frames or arrays).

These preprocessing steps may ensure that the data inputs conform to the expected format, structure, and statistical properties required by the downstream simulation unit 114. By centralizing and standardizing the data preparation workflow, the assembly unit 112 may improve the consistency, quality, and reliability of the simulation results. It also facilitates modular system design, allowing the forecasting and simulation components to be updated or retrained independently while maintaining a common data interface.

Referring now to the simulation unit 114, this component of the system is configured to execute a series of predictive simulations to estimate the likelihood of a peak load occurring on each remaining day of a defined evaluation period. In some embodiments, the simulation unit 114 includes one or more stochastic simulation models, such as Monte Carlo simulation engines, that generate multiple realizations of future load profiles. Each day within the evaluation window is treated as a random variable, where the expected load is modeled as a function of both a deterministic forecast and a probabilistic error distribution.

According to one implementation, for each day in the evaluation period, the simulation unit 114 may draw random samples from a standard normal distribution or standard t-distribution, representing potential deviations from the forecast due to model error, weather fluctuations, or behavioral uncertainty. These random samples are then used to perturb the deterministic forecast values, creating plausible future load trajectories. A single simulation run may generate one complete realization across the entire evaluation window, and this process is repeated iteratively, e.g., on the order of 100000 realizations (1E5) for a monthly forecast horizon.

The purpose of this large-scale stochastic sampling is to capture the full distribution of possible future outcomes, accounting for both expected trends and uncertainty bounds. Once the Monte Carlo simulation is complete, the results are analyzed to identify, for each realization, which day exhibits the highest load (i.e., the peak). By aggregating these outcomes across all simulations, the system constructs a day-by-day likelihood profile, quantifying the empirical probability that any given day will be the peak load day within the evaluation period.

In some embodiments, the sampled values produced during the Monte Carlo simulation process are stored in a two-dimensional array or matrix structure, where each column corresponds to a specific day in the remaining interval, and each row represents a single simulation realization. For example, in the case of a 30-day monthly interval with 100000 simulations, the resulting array would have dimensions of 100000 rows × 30 columns. This structure enables efficient parallel analysis of the simulation data and facilitates direct computation of statistical measures, such as peak day frequency and percentile thresholds.

Moreover, in some embodiments, the simulation unit 114 is configured to re-run the entire simulation process daily or at predefined intervals. This re-execution allows the system to incorporate the latest available data, including updated historical load measurements, improved forecast values, and refined error distributions derived from ongoing back testing. This rolling simulation capability ensures that the peak likelihood predictions remain current and responsive to rapidly evolving grid conditions, weather variability, and consumer behavior. It also supports real-time decision-making and adaptive control actions in the grid management platform.

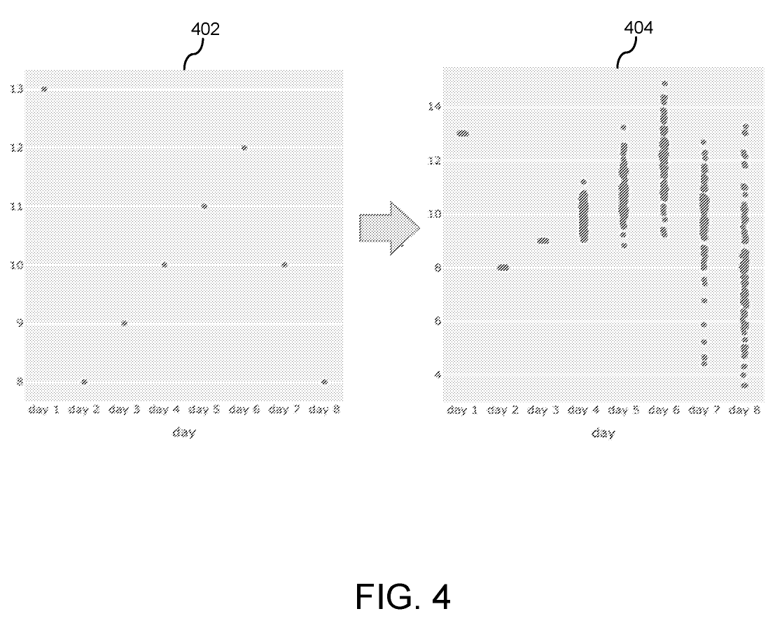

FIG. 4 illustrates an example implementation of a Monte Carlo simulation used to estimate peak load probabilities within a defined evaluation period. The left panel 402 of the figure presents the best available deterministic load forecast, shown as a continuous curve that represents the mean expected load over the upcoming days. This curve may reflect the central tendency of forecast models based on current weather, historical patterns, and exogenous variables. In contrast, the right panel 404 visualizes a large number of stochastic simulation realizations, each representing a possible future trajectory of daily load outcomes. These trajectories are generated by perturbing the deterministic forecast using error distributions derived from historical forecast performance, thus introducing realistic variability into the simulation. The result is a probabilistic ensemble of possible futures.

From this ensemble of simulated load trajectories, the likelihood of a peak occurring on any given day within the evaluation period is derived. In particular, the likelihood for a specific day is defined as the fraction of simulation realizations in which that day exhibits the maximum load value within its corresponding realization. This fractional metric effectively quantifies the probability that a given day will emerge as the monthly or interval peak, given both forecast trends and known error distributions. This method enables grid operators to make informed decisions not based on a single point forecast, but rather on a distributionally-aware view of future peak risk.

As part of the system architecture depicted in FIG. 1, a likelihood calculation unit 116 is responsible for quantifying the peak occurrence likelihood for each remaining day in the evaluation interval. Specifically, upon receiving the simulation output, the likelihood calculation unit 116 may analyze each individual realization, i.e., each possible future load scenario, and identify the day that registered the maximum load. This process is repeated across thousands of realizations. For each candidate day, the unit then computes the ratio of times that the day was selected as the peak day over the total number of simulations, yielding a day-specific likelihood score or probability score.

This score reflects a relative probability measure that enables the system to distinguish between high-risk and low-risk days with regard to potential peak occurrence. The use of probabilistic simulation for this likelihood assignment adds resilience to uncertainty in both the load forecast and external variables (e.g., weather fluctuations), resulting in a more adaptive and reliable peak prediction system. These likelihood values are subsequently passed to a label assignment unit 118 for categorization into actionable control labels, as further described in detail later.

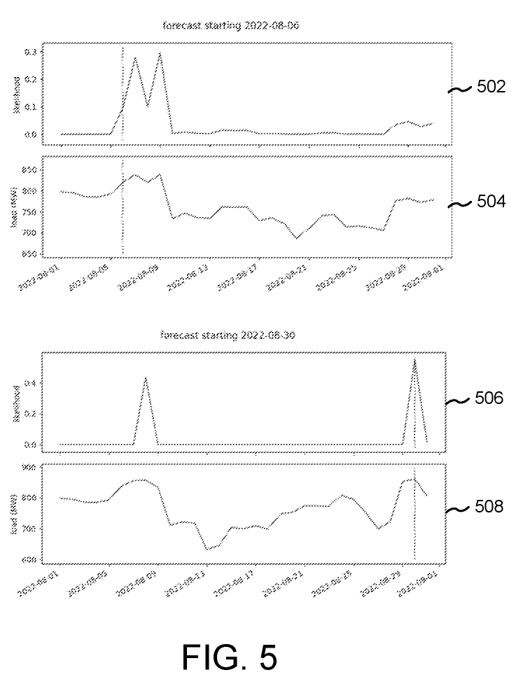

FIG. 5 illustrates example outputs of the likelihood model at two different points in time within the same monthly evaluation period, August 2022, demonstrating the temporal evolution of predicted peak probabilities based on updated load forecasts and observed peak-to-date values. The top two plots 502 and 504 in the figure represent a likelihood assessment conducted early in the month, specifically on August 6, 2022. At this point in time, the observed peak load is relatively low and the forward-looking forecast, though uncertain, shows that two days, August 7 and August 9, have the highest relative likelihoods of becoming the monthly peak. These two days stand out in the simulation results due to their higher forecasted load magnitudes relative to surrounding days. The remaining days in the month show low predicted likelihoods, as the simulation does not yet project any future load values that would clearly exceed those of August 7 or 9.

In contrast, the bottom two plots 506 and 508 in FIG. 5 correspond to a likelihood assessment performed later in the same month, on August 30, 2022. By this time, a significant portion of the evaluation window has elapsed, and actual load values have been observed for nearly the entire month. At this stage, the forecasted load for August 30 itself is slightly higher than the previously observed peak load on August 9, leading to a shift in the simulated likelihood distribution. The Monte Carlo simulation now identifies August 30 as the day with the highest likelihood of being the monthly peak, surpassing the previously favored August 9. This dynamic adjustment highlights the adaptive nature of the likelihood model, as new forecast data is received and more of the month’s actual load history is locked in, the model may re-evaluate peak probabilities accordingly.

This figure illustrates a core benefit of the disclosed platform, namely, the ability to provide continuously updated, data-driven estimates of peak probability for each remaining day in an interval, enabling operators to time their actions with greater precision. Such daily updates, based on the interplay between forecast uncertainty and peak-to-date tracking, form the foundation for operationally optimized peak demand management.

Referring back to FIG. 1, following the computation of peak occurrence likelihoods for the remaining days in an evaluation period, the grid management platform 100 may apply a label assignment process to convert these continuous likelihood values into actionable categories. This operation is performed by the label assignment unit 118, which classifies each day as either “Very Likely” (VL), “Likely” (L), or “Unlikely” (UL) to experience a peak load event. The labels are determined based on the relative likelihood value of each day in the context of the entire evaluation period and provide a qualitative representation of forecasted risk. In some embodiments, additional or alternative labels may be defined, including numerical confidence bands, probabilistic heat maps, or custom-defined tiers aligned with user-specific operational requirements or tariff structures.

This labeling framework transforms probabilistic outputs into discrete control inputs that may be easily interpreted by automated control systems or human operators. For example, a day labeled as “Very Likely” may trigger pre-scheduled DER dispatch or DR program activation, while a day labeled as “Unlikely” may suppress unnecessary interventions, preserving limited control actions for higher-risk events.

In some embodiments, the assignment of categorical labels to likelihood values is performed using optimization bin thresholds 124, which partition the probability space into discrete intervals based on a cost function. The binning process involves the transformation of a continuous likelihood output into discrete categories by identifying threshold values that minimize total cost or maximize performance metrics across historical data. This optimal binning may be carried out using statistical optimization techniques, such as grid search, cross-validation over n folds, or dynamic programming algorithms tailored for discretization.

The cost function used to determine the optimal bin thresholds may incorporate multiple operational and economic factors. These include, but are not limited to, demand charges associated with coincident peak consumption, the availability and cost of deployable resources (e.g., energy storage systems, flexible loads, or demand response programs), and other system-level constraints, such as control signal limits, asset availability, or response timing requirements. As will be described in detail later, during the model training phase, the system may evaluate historical data using multiple bin configurations and select the threshold combination that would have resulted in the lowest aggregate cost across all evaluation intervals. This cost-optimized binning strategy ensures that the classification model not only reflects statistical accuracy but also aligns with real-world operational priorities, improving both economic efficiency and decision-making reliability for utility operators and grid stakeholders.

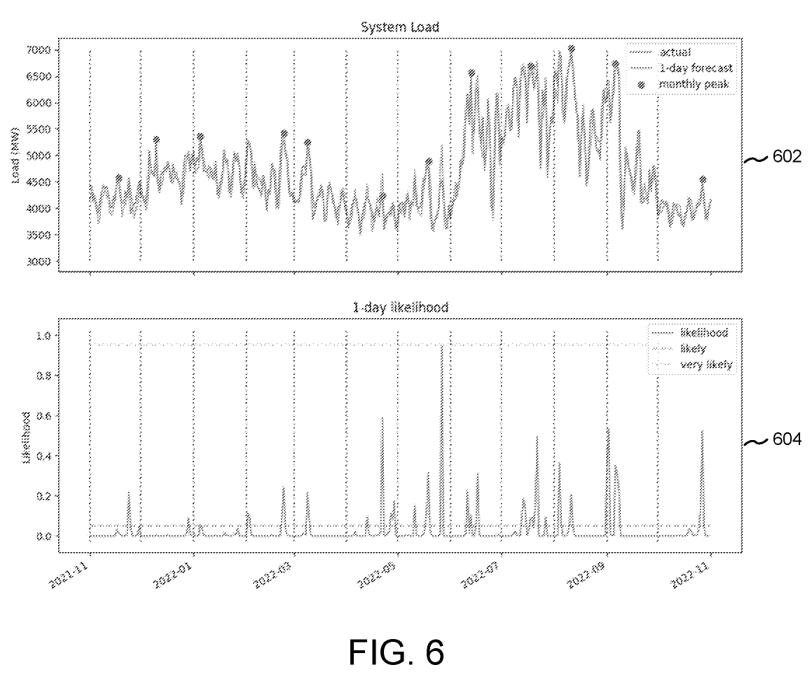

FIG. 6 illustrates two panels that demonstrate the operational effectiveness of the disclosed likelihood model over a historical period extending from November 2021 to November 2022. In the top panel 602, the actual load profile is plotted alongside the forecasted load values. For each month within the displayed time frame, the actual peak load day is explicitly marked, allowing visual alignment with predicted trends. The bottom plot 604 depicts the day-specific likelihood values computed by the Monte Carlo simulation for each day within the monthly evaluation periods. This likelihood represents the estimated probability that a given day will be the monthly peak load day, based on the simulation results generated using forecasted and historical load data and/or forecast error derived from back testing.

In the bottom plot 604, two binning thresholds are shown, which are used to discretize the continuous likelihood values into three categorical labels: “Very Likely," "Likely," and "Unlikely." These thresholds are determined based on an optimization process or a training process, as described later, using a cost-sensitive binning function. From the visualization, it can be seen that the vast majority of the actual monthly peak days fall within the “Likely” categorical label. This suggests that the likelihood model, when properly trained or further tuned, demonstrates a strong ability to cluster true peak days within an economically favorable classification, reducing both false negatives (missed peaks) and unnecessary load reduction efforts.

Following the likelihood classification for each remaining day of the evaluation period, the grid management platform 100 may generate and transmit actionable insights or control signals 140 based on the assigned label through the insight generation unit 126. For days classified as “Very Likely” or “Likely” to contain a peak load, the insight generation unit 126 may automatically issue warning signals to grid operators, facility managers, or end users. These signals may be communicated via digital alerts, email notifications, automated dashboard prompts, or application programming interface (API) calls. In some embodiments, the insight generation unit 126 may accompany the warning signal with instructions or incentives related to demand response programs, encouraging end users or participants to reduce consumption during the high-risk period.

Additionally, for entities operating controllable distributed energy resources, such as battery energy storage systems or flexible HVAC systems, the insight generation unit 126 may issue control signals to proactively schedule load shifting or on-site generation. For example, thermostats may be instructed to pre-cool a building before the peak window or raise setpoints during the window; EV chargers may delay charging cycles; or battery storage units may be discharged into the facility’s load to offset grid draw. These control signals are generated and delivered in advance of the predicted peak, ensuring sufficient ramp time and coordination with operational schedules. This combination of forecast accuracy, timely labeling, and intelligent dispatch allows the platform to reduce peak demand charges while maintaining occupant comfort, system reliability, and environmental sustainability.

Referring back to FIG. 1, in some embodiments, the grid management platform 100 may include additional functional components beyond those explicitly illustrated or described herein. These may include, but are not limited to, one or more communication units, which facilitate secure and real-time data exchange between the grid management platform and external entities such as distributed energy resources, utility operators, market aggregators, or customer-premises equipment. Communication may occur over a variety of network protocols, including but not limited to cellular, fiber, mesh, or broadband, and may support standardized communication formats such as open automated demand response (OpenADR) or message queuing telemetry transport (MQTT). In some embodiments, the communication unit may include bidirectional control interfaces that allow the system to transmit actuation signals and receive telemetry or status updates from controllable loads or sensors.

Additionally, the grid management platform 100 may incorporate one or more monitoring indicators or diagnostic modules that track the operational status, prediction accuracy, and resource availability in real time. These indicators may include system health metrics, alert thresholds, prediction confidence intervals, or performance dashboards that aid operators in understanding the reliability and responsiveness of the platform 100. For example, a monitoring indicator may alert the system administrator when likelihood classification confidence drops below a predefined threshold, or when DER availability is insufficient to act on a “Very Likely” peak event prediction. Such components improve system resilience, transparency, and decision support.

These and other optional subsystems may be modularly integrated to enhance the adaptability, security, and scalability of the grid management platform 100 without departing from the core principles of the disclosed platform.

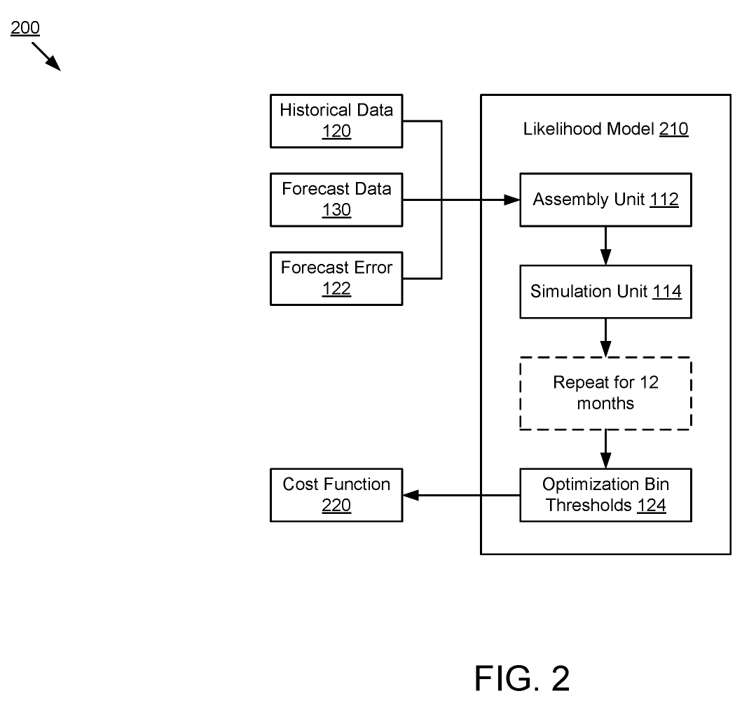

Referring now to FIG. 2, an example system architecture 200 for training the likelihood model 210 is further illustrated. In the illustrated embodiment, the training system operates as a preprocessing and optimization layer prior to deployment in a live operational environment. The system architecture 200 is configured to receive multiple types of input data, including historical load records (referred to as historical data 120), forecasted future demand data (referred to as forecast data 130), and historical forecast error distributions (referred to as forecast error 122) derived from back testing. These inputs are aggregated and processed by an assembly unit 112, which performs data normalization, feature engineering, and structuring into formats compatible with the subsequent simulation workflow. The simulation unit 114 executes a large-scale Monte Carlo simulation, generating numerous synthetic demand scenarios for the defined forecast horizon. Each realization simulates possible future peak days (e.g., 12 months) by incorporating both expected forecast values and random variability modeled from historical forecast error data.

Based on the outcomes of the simulation, a likelihood calculation unit (not shown) determines the empirical probability of each day within the forecast window being the peak load day, calculated as the proportion of simulation runs in which that day registers the highest demand. These probabilities are then passed to a label assignment unit (not shown), which classifies each day into categorical bins, such as “Very Likely,” “Likely,” or “Unlikely”, based on optimized threshold values (referred to as optimization bin thresholds 124), similarly to the description related to FIG. 1. The optimization bin thresholds 124 used to discretize likelihood scores are not arbitrarily chosen but are instead derived through a cost-based optimization process, as described earlier. This cost function 220 may incorporate factors such as demand charges, dispatchable resource constraints, and control event costs, ensuring that the classification strategy aligns with economic priorities.

Once the model training process is complete and the parameters, including forecast model weights, simulation sampling rules, and bin thresholds, are optimized, the trained likelihood model 210 may be embedded into the real-time grid management platform 100 (e.g., as the likelihood model 110 in FIG. 1). There, the trained model may dynamically assess peak risk each day, continuously updating predictions based on the most current load forecasts and observed data. The trained model enables the grid platform to make operationally optimized control decisions, such as activating demand response events, scheduling distributed energy resource dispatch, or issuing peak event warnings to stakeholders.

In some embodiments, during the training phase of the likelihood model, multiple internal parameters may be systematically optimized to improve the accuracy and economic utility of peak load classification. These parameters may include (i) forecast model weights, (ii) Monte Carlo simulation sampling rules, and (iii) bin thresholds used for classifying likelihood values into actionable categories (e.g., “Very Likely”, “Likely”, “Unlikely”).

In some embodiments, to optimize the forecast model weights, the system may employ supervised machine learning techniques, such as time-series cross-validation or sliding window training, to fit predictive models on historical load data. The model may incorporate autoregressive components, seasonal trends, and exogenous variables like weather or calendar effects. Model parameters may be tuned using metrics such as mean absolute percentage error (MAPE) and root mean squared error, ensuring that short- and medium-term forecasts closely align with observed patterns.

The Monte Carlo simulation sampling rules, such as the number of realizations, choice of distribution (e.g., normal or t-distribution), and variance scaling, may be calibrated using historical forecast error distributions obtained from back testing. During training, multiple configurations may be evaluated to identify sampling strategies that yield likelihood distributions most consistent with actual peak occurrences in the historical record. Simulation robustness is assessed based on predictive accuracy, stability across forecast horizons, and responsiveness to real-time load shifts.

Further, the bin thresholds for likelihood classification may be optimized using a cost-sensitive objective function (also referred to as a bin threshold optimizer). As described above, this function may quantify the economic impact of correct and incorrect classifications by assigning costs to outcomes such as missed peaks (false negatives), unnecessary activations of DERs or DR programs (false positives), and accurate predictions. The system may apply grid search or evolutionary algorithms to evaluate threshold combinations across multiple months or seasons. The set of thresholds that minimizes total operational cost, subject to real-world constraints like resource availability or program limits, may be selected as the optimal configuration.

Together, this multistage optimization process may produce a trained likelihood model 210 that is not only statistically accurate but also operationally efficient, enabling utility operators to act on forecasts with confidence that actions taken are justified by both technical performance and operational outcomes.

In some embodiments, subseasonal weather forecasts may be taken into consideration in the disclosed load forecast model, which may further improve the peak load forecast. In the following descriptions, the load forecast model without long-range weather forecasts will be referred to as the baseline model. The load forecast using long-range weather forecasts will be called the subseasonal model.

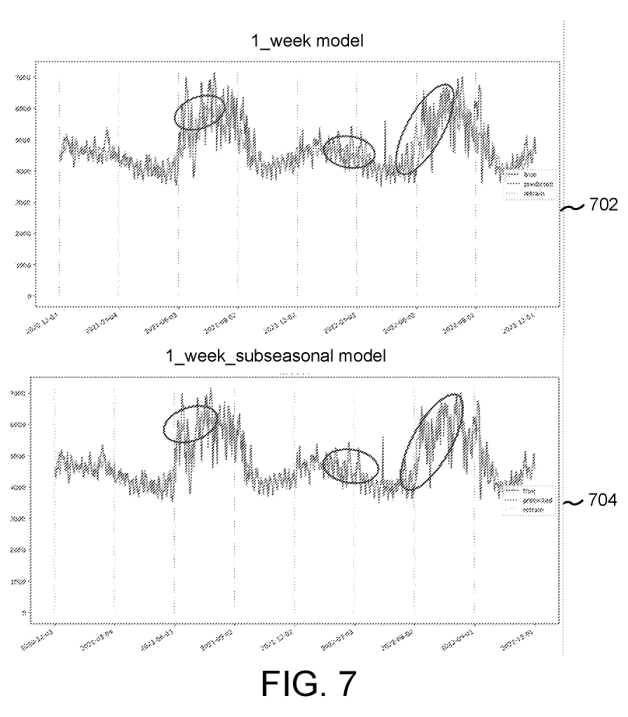

FIG. 7 provides a side-by-side comparison of predicted load versus actual load over a 12-month period using two forecasting models: a baseline 1-week model (top panel) 702 and a 1-week model enhanced with subseasonal weather features (bottom panel) 704. The Y-axis represents electrical load in megawatts (MW), while the X-axis denotes time, spanning from December 2020 to December 2021. In both plots 702 and 704, one line represents the predicted load, and another line indicates the actual recorded load. Ellipses highlight key periods where model performance diverges, illustrating points of significant forecasting error in the baseline model and improvements gained via subseasonal enhancements.

In the top panel 702, which displays the output from the baseline 1-week model, there are multiple regions where the forecast either underestimates or overshoots actual demand, particularly during periods of rapid load change or high variability. Notable discrepancies can be observed in the spring and summer months (e.g., March-May and July-August 2021), where the model consistently underpredicts peak demand. These forecasting inaccuracies are primarily due to the baseline model’s limited ability to incorporate long-range temperature or weather anomalies that drive large deviations in electricity consumption.

The bottom panel 704 shows the same forecast interval using a 1-week subseasonal model, which incorporates extended-range weather forecasts and meteorological trends as additional features. As evidenced by the tighter alignment between the predicted and actual load lines in the circled regions, the subseasonal model exhibits significant improvements in forecast accuracy, particularly during the same periods of seasonal transition or weather-driven peaks. This enhancement allows the model to better anticipate both the timing and magnitude of peak loads, reducing lag and overshoot in the predictions. For example, in the July-August period, the subseasonal model captures both the peak shape and its duration more accurately than the baseline, indicating a stronger response to weather-related load dynamics.

Collectively, FIG. 7 highlights the improved predictive power of subseasonal models for weekly horizon forecasts. By reducing forecast error during critical periods, especially around peak events, this model enhancement supports more accurate peak probability simulations, enabling the grid management platform to trigger load control actions with greater confidence and timeliness. These improvements are important for optimizing demand-side responses, minimizing peak-related charges, and supporting grid reliability.

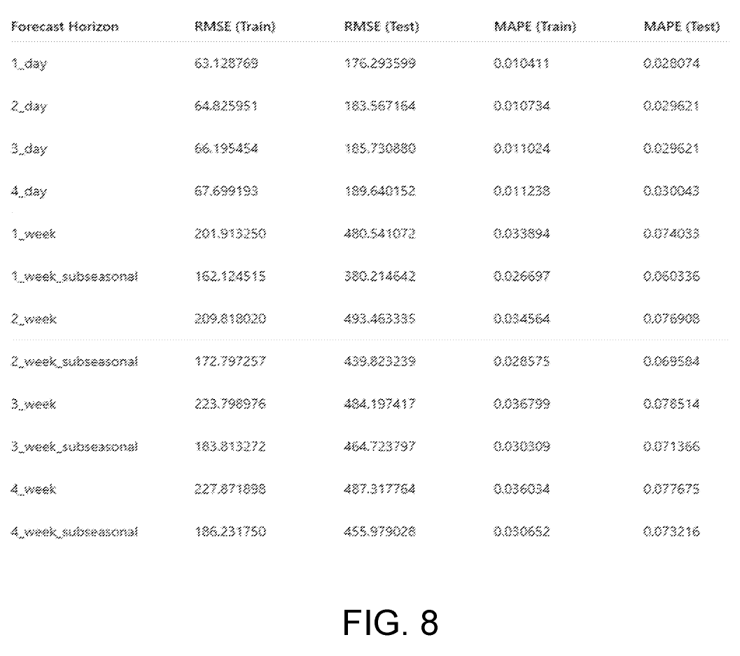

In some embodiments, the farther away a day is from the starting date, the less accurate for a predicted load for a multi-week load forecast. FIG. 8 presents a tabular comparison of load forecasting accuracy for different forecast horizons, evaluated using two standard metrics: root mean squared error (RMSE) and mean absolute percentage error (MAPE). These metrics are shown for both the training and testing datasets to assess model generalization and predictive stability. The rows in the table correspond to forecast intervals ranging from short-term (1-day to 4-day and 1-week forecasts) to extended forecast horizons (2-week, 3-week, and 4-week), with additional rows that incorporate subseasonal forecasting enhancements for the 1-week to 4-week intervals.

The baseline short-term forecasts (e.g., 1-day and 2-day) demonstrate the lowest RMSE and MAPE values, as expected due to their reliance on recent, high-confidence data. For example, the 1-day forecast achieves a test RMSE of approximately 176.3 MW and a MAPE of 2.8%, indicating high accuracy. However, as the forecast horizon increases (e.g., 1-week to 4-week), both RMSE and MAPE steadily worsen, with the baseline 4-week model reaching a test RMSE of 487.3 MW and a MAPE of 7.77%. This degradation in accuracy is a well-established challenge in load forecasting due to compounding uncertainties in weather, demand, and usage behavior over time.

Importantly, the table also highlights the benefit of incorporating subseasonal weather data. Across all extended forecast horizons (1-week to 4-week), the subseasonal models outperform their baseline counterparts in both RMSE and MAPE. For instance, the 4-week subseasonal model reduces the test RMSE from 487.3 MW to 455.9 MW and the MAPE from 7.77% to 7.32%. Similarly, the 1-week subseasonal model improves test RMSE from 480.5 MW to 380.2 MW and reduces MAPE from 7.4% to 6.0%. These improvements demonstrate that incorporating long-range meteorological signals enhances the ability of the model to predict peak demand conditions with higher reliability, especially when operating beyond the short-term window. This improvement in forecast precision directly supports the effectiveness of the platform’s peak probability simulation engine and the accuracy of the grid management recommendations.

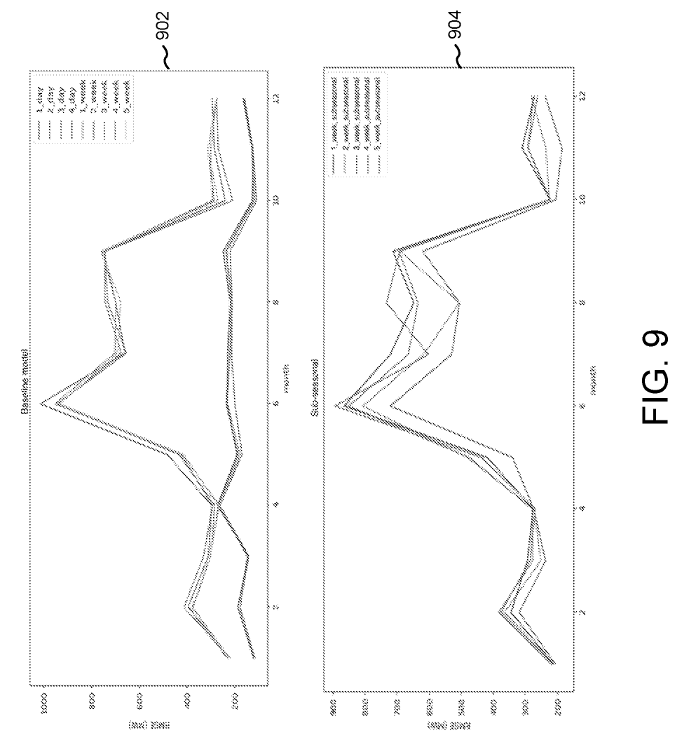

FIG. 9 further illustrates an example error comparison of predicted load by month. Specifically, the two line plots presented in the figure compare the monthly RMSE of load forecasts generated by two different models: a baseline forecast model (top panel) 902 and a subseasonal weather-enhanced forecast model (bottom panel) 904. Each line in both plots represents forecast accuracy across a different forecast horizon, ranging from short-term (1-day to 5-day) to medium- and long-term horizons (1-week to 5-weeks). The X-axis denotes the calendar month (1 through 12), while the Y-axis measures RMSE in megawatts (MW), with lower values indicating more accurate predictions.

In the top panel (baseline model) 902, the RMSE values are lowest for short horizons (e.g., 1-day and 2-day forecasts) and increase as the forecast horizon extends. This behavior aligns with expected degradation in forecast precision over time. However, across most months, all forecast horizons maintain relatively similar trends, with a noticeable peak in error values during the summer months, particularly in June (month 6) and July (month 7), where RMSE spikes to over 900 MW. This reflects increased difficulty in accurately forecasting during periods of high variability in demand, likely due to weather-induced volatility or increased cooling loads.

In contrast, the bottom panel (subseasonal model) 904 demonstrates the performance of forecasts that integrate subseasonal meteorological data, such as long-range temperature and humidity forecasts. The inclusion of this weather intelligence results in consistently lower RMSE values across all forecast horizons, particularly in the summer months, where accuracy gains are most pronounced. For example, while RMSE in the baseline model exceeded 900 MW in June for longer horizons, the subseasonal model maintains values closer to 800 MW or lower. The gap between 1-week and 5-week forecast accuracy also narrows, demonstrating that weather-enhanced models improve medium- and long-range forecast reliability.

Collectively, these results validate that incorporating subseasonal weather forecasting into the load prediction process meaningfully improves forecast precision, especially during critical high-load periods. This enhancement directly benefits the platform’s peak probability simulations and likelihood model accuracy, enabling more precise demand management and better alignment of control actions with true system conditions.

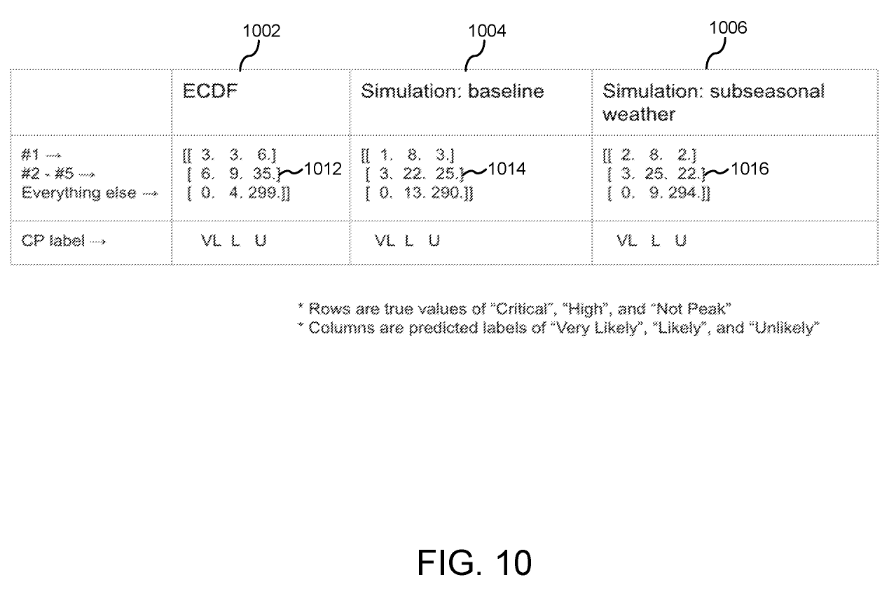

FIG. 10 further illustrates an example performance in backtesting using a confusion matrix. Specifically, to evaluate the performance of the disclosed likelihood model, a backtesting study was conducted comparing three different approaches for peak classification: (i) an empirical cumulative distribution function (ECDF)-based method 1002, (ii) a Monte Carlo simulation approach utilizing a baseline load forecast model 1004, and (iii) a Monte Carlo simulation approach incorporating a subseasonal weather-enhanced forecast model 1006. The evaluation spanned twelve months and used a confusion matrix format in which rows represent the true classification labels of each day, namely, “Critical” (ranked #1 peak), “High” (ranked #2 through #5), or “Not Peak” (all other days), and columns represent the predicted labels output by the likelihood model, VL, L, or UL.

In the ECDF-based method, shown in the leftmost matrix 1012, the model correctly identified 3 of the true Critical peaks as “Very Likely,” but misclassified the remaining 6 as “Unlikely,” and 3 as merely “Likely.” Similarly, only 9 of the High peak days were classified as “Likely,” while 35 were incorrectly labeled as “Unlikely,” demonstrating that the ECDF approach exhibits a tendency toward conservative classification, favoring underprediction to avoid false positives. Notably, the ECDF model classified 299 out of 303 “Not Peak” days correctly as “Unlikely,” showing high specificity but relatively lower recall for peak events.

In contrast, the middle matrix 1014 representing the simulation approach using the baseline forecast model demonstrated a more balanced classification profile. It correctly classified 1 Critical day as “Very Likely” and 8 as “Likely,” while reducing the misclassification rate of High peak days. Specifically, 22 of the 50 High peak days were correctly labeled as “Likely,” compared to only 9 under the ECDF method. This model slightly increased false positives for “Not Peak” days (13 misclassified as “Likely”) but significantly improved the recall of peak-related events, offering a more proactive strategy for demand response.

The rightmost matrix 1016 reflects the simulation approach enhanced by subseasonal weather forecasting. This model correctly classified 2 out of 3 Critical peak days as “Very Likely,” and 25 out of 50 High days as “Likely,” outperforming the baseline model in both categories. Furthermore, it reduced the number of High days misclassified as “Unlikely” to 22, while correctly identifying 294 “Not Peak” days as “Unlikely,” showing a better balance of precision and recall. This performance suggests that incorporating long-range weather data into the simulation significantly improves the model’s ability to predict future peak events with higher fidelity.

Collectively, these results validate the efficacy of the Monte Carlo simulation approach, particularly when paired with subseasonal forecasting, in improving actionable peak predictions. Such accuracy enables better grid management decisions, improves timing for DER or DR dispatch, and enhances cost-saving opportunities under time-sensitive demand charge structures, as described further in the following example applications of the disclosed platform.

### Example Applications

### 1. Utility Company Coincident Peak Charge Reduction

Electric utilities are often subject to CP charges, fees imposed based on their demand during the system-wide peak hour(s). These charges may represent a substantial portion of a utility’s total electricity costs, especially under tariffs such as the 12 CP or 1 CP models. Using the proposed platform, a utility may accurately forecast the likelihood of upcoming CP events. The system evaluates historical usage patterns, current forecast data, and uncertainty via Monte Carlo simulations. When a high-likelihood peak hour is predicted, the system automatically issues control signals to DERs such as batteries or smart load devices, such as smart inverters with load management, smart HVAC systems, smart water heaters, smart plugs and switches, smart thermostats, electric vehicle chargers, etc. These devices may be internet-connected, support remote control, and thus may receive control signals from the disclosed platform. For example, the control signals sent to the smart thermostats may control the thermostats to automatically pre-cool or pre-heat a home in advance of a predicted peak hour, then reduce HVAC use during the peak (e.g., raise AC setpoint from 72° F to 78° F between 4–6 PM), the control signals sent to the smart EV chargers may control the charges to automatically pause or reduce charging rate during peak demand hours, then resume when off-peak pricing resumes, the control signals sent to the smart water heaters may control the heaters to automatically heat water during off-peak hours and turn off or go into eco-mode during the afternoon peak, the control signals sent to the smart outlets/plugs may control the outlets/plugs to automatically turn off high-load appliances like dehumidifiers or space heaters during a critical peak event, etc. In some embodiments, the smart controls may also trigger certain DR programs to reduce usage during these critical periods. For example, in view of high-likelihood peak day, the control signals may automatically send messages for affected customers about critical peak pricing, e.g., utility may automatically send a 12-24-hour notice to declare a “critical peak event,” indicating elevated pricing during the critical peak so as to provide strong incentive to customers to reduce usage on the peak day. By preemptively curbing demand, utilities may significantly lower their CP exposure.

### 2. Smart City Grid Management

In a smart city environment, the electricity grid often integrates a wide range of infrastructure components, including electric vehicle charging stations, adaptive street lighting systems, and intelligent heating, ventilation, and air conditioning systems deployed in municipal facilities. Efficiently managing these heterogeneous and distributed electrical loads during periods of elevated demand represents a significant operational challenge. The disclosed grid management platform provides predictive analytics capabilities that allow city grid operators to forecast peak demand windows by analyzing real-time environmental conditions, historical consumption patterns, and forecast uncertainty. Based on the output from the likelihood model, the system may execute pre-defined or dynamic control actions, such as dimming LED-based streetlights, deferring or staggering EV charging loads at public charging stations, and pre-conditioning municipal buildings to reduce HVAC demand during anticipated peak hours. These control strategies result in a reduction in overall system peak demand, mitigate exposure to volatile wholesale energy pricing, and enhance grid reliability and resilience for critical public infrastructure.

### 3. EV Fleet Charging Optimization

Operators of electric vehicle fleets, including but not limited to logistics providers, municipal transportation departments, and commercial delivery services, must contend with the operational challenge of managing high-volume charging loads. Simultaneous charging of multiple EVs during regional or system-wide peak demand periods may lead to substantial demand charges imposed by utilities. The disclosed electricity peak demand forecast mediated grid management platform provides predictive insight into forthcoming peak intervals, enabling such fleet operators to proactively adjust their charging operations. Upon identifying high-likelihood peak windows, the platform generates optimized charging schedules, which may involve staggering vehicle charging sessions overnight or outside of peak pricing windows. Vehicles may be prioritized based on operational schedules, expected deployment times, or battery state-of-charge. Furthermore, where on-site renewable generation (e.g., photovoltaic systems) or battery energy storage systems are available, the platform may coordinate their dispatch to support charging needs while minimizing grid draw during peak periods. These optimizations help reduce electricity costs, mitigate exposure to demand-based charges, and ensure high fleet readiness and energy reliability.

### 4. Commercial Campus Energy Optimization

Large campuses such as universities, hospitals, or technology parks often contain multiple buildings with significant, variable energy demands. These institutions are typically billed under time-of-use or demand-based pricing structures, making them vulnerable to cost spikes during high-load hours. Using the platform, campus facility managers may receive early warnings about potential peak hours. The system uses historical building energy usage, weather forecasts, and occupancy patterns to simulate future demand scenarios. When a peak is imminent, it issues recommendations such as pre-cooling HVAC systems, delaying non-essential activities, or discharging on-site battery storage. In some cases, automated control actions may be directly executed via the building management system. This results in reduced operational expenses and aligns with sustainability and decarbonization goals.

### 5. Battery Storage Dispatch Scheduling

Battery energy storage systems, particularly when co-located or integrated with renewable energy resources such as photovoltaic (PV) arrays, provide essential load-shaping capabilities and serve as critical assets for demand management. However, the operational value of such systems depends significantly on the timing and precision of dispatch decisions. The disclosed grid management platform employs a probabilistic peak prediction model that leverages grid-level load forecasts, substation-specific demand trends, and meteorological data to identify future time windows with an elevated likelihood of coincident peak events or price volatility. Based on these inputs, the system calculates an optimized discharge schedule for the battery energy storage systems, ensuring that energy is dispatched during periods of highest cost impact or greatest grid need. Concurrently, the platform schedules battery recharging during intervals characterized by low wholesale electricity prices or abundant solar generation, thereby minimizing costs and supporting energy balance. This coordinated operation not only improves the return on investment of battery assets but also contributes to grid stability and reduces reliance on high-emission peaking generators.

### 6. Energy Market Participation and Arbitrage

For energy aggregators and virtual power plant operators, effective participation in electricity markets necessitates accurate forecasting of both regional load conditions and market price dynamics. The disclosed grid management platform provides such operators with real-time and forecast-based assessments of the likelihood of regional or independent system operator-level peak events. Utilizing this predictive intelligence, the aggregator may proactively position its portfolio by bidding load curtailments into day-ahead or real-time electricity markets, functionally analogous to a generation resource. The platform facilitates monetization of a diverse range of flexible distributed energy resources, including but not limited to thermostatically controlled loads, commercial and industrial demand curtailment contracts, and grid-connected battery systems. By dispatching or curtailing these assets in synchrony with predicted peak periods or price spikes, the aggregator not only earns market revenues and incentive payments but also contributes to overall grid reliability, frequency regulation, and emissions reduction objectives. This embodiment supports a broader transition to a decentralized, intelligent, and carbon-aware electric grid.

It should be noted that the above example applications are provided for illustrative purposes, but not for limitations. Additional applications of the disclosed grid management system are also possible and contemplated by the disclosure.

### Computer Embodiments

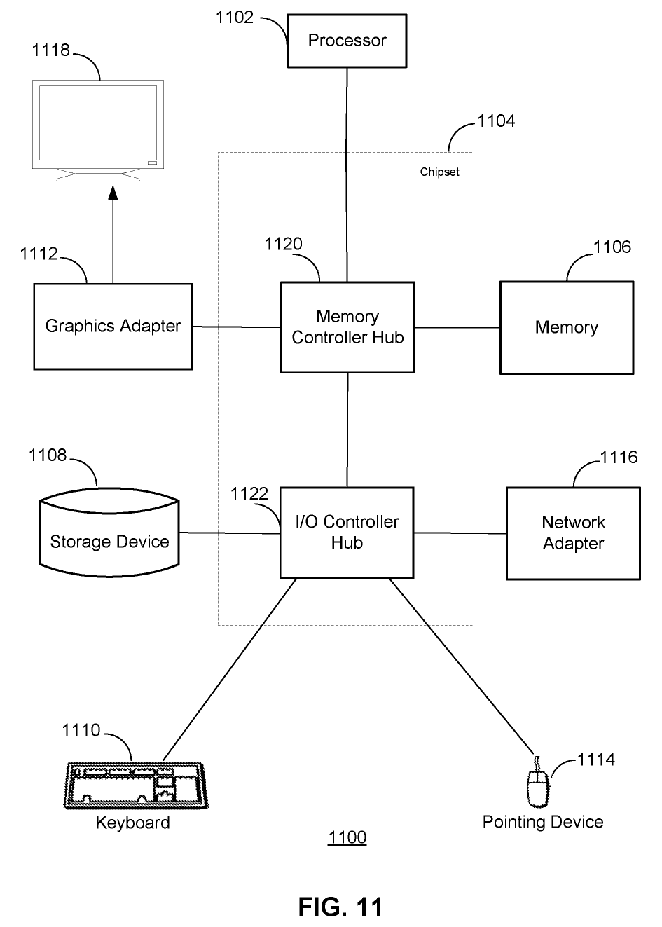

FIG. 11 depicts an example computing device 1100 for implementing systems and methods described in reference to FIGS. 1-10. Examples of a computing device may include a personal computer, desktop computer, laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, edge devices, IoT devices, and the like.

In some embodiments, the computing device 1100 includes at least one processor 1102 coupled to a chipset 1104. The chipset 1104 includes a memory controller hub 1120 and an input/output (I/O) controller hub 1122. A memory 1106 and a graphics adapter 1112 are coupled to the memory controller hub 1120, and a display 1118 is coupled to the graphics adapter 1112. A storage device 1108, an input interface 1114, and a network adapter 1116 are coupled to the I/O controller hub 1122. Other embodiments of the computing device 1100 have different architectures.

The storage device 1108 is a non-transitory computer-readable storage medium such as a hard drive, compact disk read-only memory (CD-ROM), DVD, or a solid-state memory device. The memory 1106 holds instructions and data used by the processor 1102. The input interface is a touch-screen interface, a mouse, a trackball, or other types of input interface, a keyboard 1110, or some combination thereof, and is used to input data into the computing device 1100. In some embodiments, the computing device 1100 may be configured to receive input (e.g., commands) from the input interface 1114 via gestures from the user. The graphics adapter 1112 displays images and other information on the display 1118. The network adapter 1116 couples the computing device 1100 to one or more computer networks.

The computing device 1100 is adapted to execute computer program modules for providing the functionality described herein. As used herein, the term “module” refers to computer program logic used to provide the specified functionality. Thus, a module may be implemented in hardware, firmware, and/or software. In one embodiment, program modules are stored on the storage device 1108, loaded into the memory 1106, and executed by the processor 1102.

The types of computing devices 1100 may vary from the embodiments described herein. For example, the computing device 1100 may lack some of the components described above, such as graphics adapters 1112, input interface 1114, and displays 1118. In some embodiments, a computing device 1100 may include a processor 1102 for executing instructions stored in a memory 1106.

The methods disclosed herein may be implemented in hardware or software, or a combination of both. In one embodiment, a non-transitory machine-readable storage medium, such as one described above, is provided, the medium comprising a data storage material encoded with machine-readable data which, when using a machine programmed with instructions for using said data, is capable of displaying any of the datasets and execution and results of this disclosure. Such data may be used for a variety of purposes. Embodiments of the methods described above may be implemented in computer programs executing on programmable computers, comprising a processor, a data storage system (including volatile and non-volatile memory and/or storage elements), a graphics adapter, an input interface, a network adapter, at least one input device, and at least one output device. A display is coupled to the graphics adapter. Program code is applied to input data to perform the functions described above and generate output information. The output information is applied to one or more output devices in a known fashion. The computer may be, for example, a personal computer, microcomputer, or workstation of conventional design.

Each program may be implemented in a high-level procedural or object-oriented programming language to communicate with a computer system. However, the programs may be implemented in assembly or machine language, if desired. In any case, the language may be a compiled or interpreted language. Each such computer program is preferably stored on a storage media or device (e.g., ROM or magnetic diskette) readable by a general or special purpose programmable computer, for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner to perform the functions described herein.

The databases thereof may be provided in a variety of media to facilitate their use. The databases of the present disclosure may be recorded on computer-readable media, e.g., any medium that may be read and accessed directly by a computer. Such media include, but are not limited to: magnetic storage media, such as floppy discs, hard disc storage media, and magnetic tape; optical storage media such as CD-ROM; electrical storage media such as RAM and ROM; and hybrids of these categories, such as magnetic/optical storage media. One skilled in the art may readily appreciate how any of the presently known computer-readable media may be used to create a manufacture comprising a recording of the present database information. “Recorded” refers to a process for storing information on a computer-readable medium, using any such methods as known in the art. Any convenient data storage structure may be chosen, based on the means used to access the stored information. A variety of data processor programs and formats may be used for storage, e.g., a word processing text file, database format, etc.

What is claimed is:

1. A grid management system, comprising:
a processor; and
a memory, coupled to the processor, configured to store executable instructions that, when executed by the processor, cause the processor to:
receive historical data and forecast data for an evaluation interval and determine a likelihood, using a likelihood model, that each remaining day in the interval will be a peak load day;
generate a plurality of stochastic realizations of future load values via a simulation;
compute, for each day, a likelihood based on a frequency that the day is the peak load day across the realizations; and
generate actionable insights or control signals for controlling grid-connected assets based on computed likelihoods.

2. The system of claim 1, wherein the executable instructions further cause the processor to preprocess the historical data and the forecast data, including applying data cleaning, feature engineering, and formatting operations.

3. The system of claim 1, wherein the simulation uses forecast error data obtained from back testing to define probabilistic distributions used in the simulation.

4. The system of claim 1, wherein the historical data includes past load measurements, hourly market prices, weather variables, and seasonality features.

5. The system of claim 1, wherein the forecast data includes deterministic and/or stochastic forecasts for future load values.

6. The system of claim 1, wherein the executable instructions further cause the processor to assign each day a label selected from at least “Very Likely,” “Likely,” and “Unlikely,” based on optimized cost thresholds.

7. The system of claim 6, wherein the cost thresholds are computed based on a cost function incorporating one or more of demand charges, deployable energy resources, control constraints, or forecast uncertainty.

8. The system of claim 1, wherein the control signals are transmitted to distributed energy resources or load assets to reduce or shift electricity consumption.

9. The system of claim 1, wherein the likelihood model is implemented using a machine learning framework supporting autoregressive time series forecasting.

10. The system of claim 1, wherein the executable instructions further cause the processor to update simulation and likelihood calculations daily based on newly observed load data and revised forecasts.

11. A method for electricity peak demand forecast-mediated grid management, comprising:
receiving historical data and forecast data for an evaluation interval;
generating a plurality of stochastic realizations of future load values using a simulation process;
determining, for each day in the interval, a likelihood of being a peak load day based on simulation outcomes; and
generating actionable insights or control signals for controlling grid-connected assets in response to determined likelihoods.

12. The method of claim 11, further comprising performing back testing on prior forecast models to estimate forecast errors, and incorporating the forecast errors into the simulation process.

13. The method of claim 11, further comprising assigning a categorical label to each day using a bin threshold optimizer that minimizes a total operational cost.

14. The method of claim 11, wherein the simulation process comprises sampling random variables for each day from a normal, t-distribution or other statistical distributions representing load forecast error.

15. The method of claim 11, wherein the control signals are transmitted to devices including one or more of battery energy storage systems, HVAC systems, electric vehicle chargers, or industrial load controllers.

16. The method of claim 11, wherein the forecast data includes daily and weekly forecasts derived from multiple weather data sources.

17. The method of claim 11, wherein the actionable insights comprise peak warnings sent to users or operators via email, alerts, or graphical dashboards.

18. The method of claim 11, wherein the historical data is augmented by derived load pattern insights generated using a machine learning or generative AI model.

19. The method of claim 11, comprising updating simulation and likelihood scores on a daily basis as new forecast and load data become available.

20. The method of claim 11, wherein the actionable insights include triggering participation in demand response programs or dynamic pricing adjustments.
